(19) United States
(12) Patent Application Publication
(10) Pub. No.: US 2024/0241719 A1
(43) Pub. Date: Jul. 18, 2024

(54) IN-VEHICLE CONTROL DEVICE, VEHICLE, VERSION MATCH CHECK METHOD OF APPLICATION, AND NON-TRANSITORY STORAGE MEDIUM

(71) Applicant: TOYOTA JIDOSHA KABUSHIKI KAISHA, Toyota-shi (JP)

(72) Inventors: Kazuyoshi SHIOHARA, Nisshin-shi (JP); Takayuki FUJIMOTO, Seto-shi (JP)

(73) Assignee: TOYOTA JIDOSHA KABUSHIKI KAISHA, Toyota-shi (JP)

(21) Appl. No.: 18/522,501

(22) Filed: Nov. 29, 2023

(30) Foreign Application Priority Data
Jan. 18, 2023 (JP) 2023-005822

(51) Int. Cl. G06F 8/71

(52) U.S. Cl. CPC G06F 8/71

(57) ABSTRACT

An in-vehicle control device is configured to execute a plurality of applications that provides a service. The in-vehicle control device includes a processing circuit configured to collectively acquire, from in-vehicle equipment, equipment information based on which a version match check of each of the applications is performed, the equipment information being information on the in-vehicle equipment. The version match check is a check performed for confirming that in-vehicle equipment necessary for providing the service is installed in a vehicle. Each of the applications is configured to start the service under a condition that the version match check is completed.

### CROSS-REFERENCE TO RELATED APPLICATION

This application claims priority to Japanese Patent Application No. 2023-005822 filed on Jan. 18, 2023, incorporated herein by reference in its entirety.

### BACKGROUND

### 1. Technical Field

The disclosure relates to an in-vehicle control device, a vehicle, a version match check method of an application, and a non-transitory storage medium.

### 2. Description of Related Art

An electronic control unit (ECU) installed in a vehicle performs a version match check of an application when updating or starting the application. In the version match check, the ECU confirms whether all in-vehicle equipment necessary for performing services provided by the application is installed in the vehicle.

Japanese Unexamined Patent Application Publication No. 2019-159399 (JP 2019-159399 A) describes a vehicle control system made up of a plurality of ECUs. The vehicle control system sets one of the ECUs as a representative ECU. The representative ECU acquires versions of software of the other ECUs when the power of the vehicle is turned on. The representative ECU then confirms whether the versions of the software of the other ECUs are appropriate.

### SUMMARY

A great number of applications perform version match checks in ECUs that provide a wide variety of services. When a great number of applications individually perform version match checks, each application may place equipment information inquiries for the same in-vehicle equipment redundantly, resulting in excessive processing overhead.

An in-vehicle control device according to a first aspect of the present disclosure is configured to execute a plurality of applications that provides a service. The in-vehicle control device includes a processing circuit configured to collectively acquire, from in-vehicle equipment, equipment information based on which a version match check of each of the applications is performed, and the equipment information is information on the in-vehicle equipment. The version match check is a check performed for confirming that in-vehicle equipment necessary for providing the service is installed in a vehicle. Each of the applications is configured to start the service under a condition that the version match check is completed.

A vehicle according to a second aspect of the present disclosure includes the in-vehicle control device according to the first aspect.

A method according to a third aspect of the present disclosure is a method for performing a version match check of a plurality of applications that provides a service, in an in-vehicle control device that executes the applications. The method includes collectively acquiring, by the in-vehicle control device executing a single program stored in the in-vehicle control device, from in-vehicle equipment, equipment information based on which the version match check is performed, and the equipment information is information on the in-vehicle equipment. The version match check is a check performed for confirming that in-vehicle equipment necessary for providing the service is installed in a vehicle. Each of the applications is configured to start the service under a condition that the version match check is completed.

A non-transitory storage medium according to a fourth aspect of the present disclosure stores instructions that are executable by an in-vehicle control device configured to execute a plurality of applications providing a service, and that cause the in-vehicle control device to perform functions. The functions include collectively acquiring, from in-vehicle equipment, equipment information based on which a version match check of each of the applications is performed, and the equipment information is information on the in-vehicle equipment. Each of the applications is configured to start the service under a condition that the version match check is completed. The version match check is a check for confirming that in-vehicle equipment necessary for providing the service is installed in a vehicle.

According to the above aspect, acquisition of equipment information for the version matching check of each application is collectively performed. Accordingly, redundant acquisition of equipment information from the same in-vehicle equipment is reduced. Thus, generation of excessive processing overhead due to the version match check can be suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating a configuration of an embodiment of an in-vehicle control device;

FIG. 2 is a table showing in-vehicle equipment for which each application of the in-vehicle control device needs a version match check;

FIG. 3 is a table showing a configuration of a version match check (VMC) table stored in memory of the in-vehicle control device;

FIG. 4 is a sequence diagram showing processing procedures performed after starting of the in-vehicle control device; and

FIG. 5 is a sequence diagram showing processing procedures performed after starting in a modification of the in-vehicle control device.

### DETAILED DESCRIPTION OF EMBODIMENTS

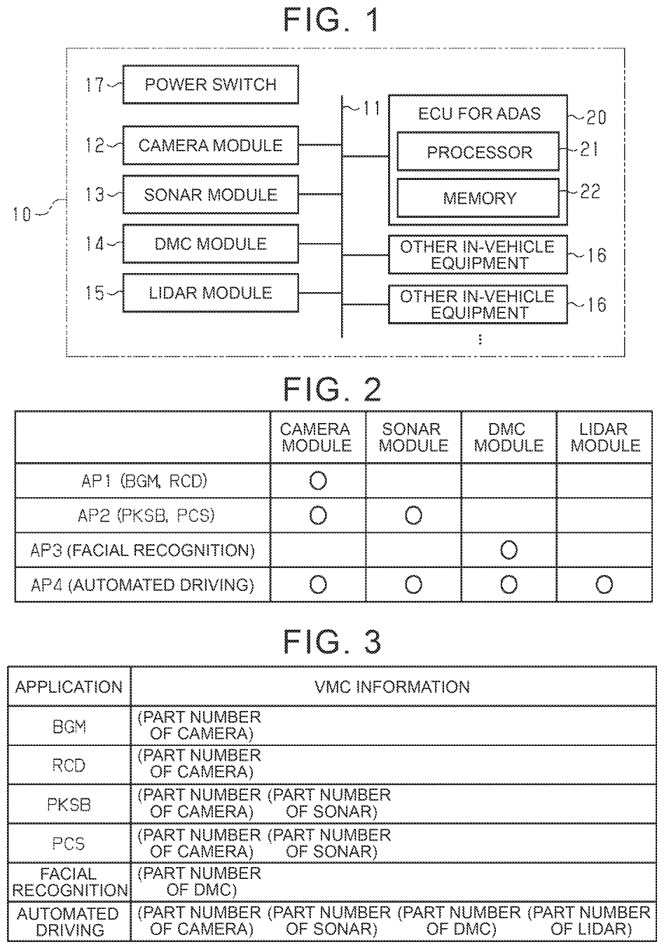

An embodiment of an in-vehicle control device will be described in detail below with reference to FIGS. 1 to 4.

### Configuration of In-vehicle Control Device

First, a configuration of the present embodiment will be described with reference to FIG. 1. A vehicle 10 is equipped with an electronic control unit (ECU) 20 that makes up an advanced driver-assistance system (ADAS), as an in-vehicle control device. The ECU 20 is connected to an in-vehicle communication network 11. Various types of in-vehicle equipment are connected to the in-vehicle communication network 11. The in-vehicle equipment connected to the in-vehicle communication network 11 includes a camera module 12, a sonar module 13, a driver monitoring camera (DMC) module 14, and a Lidar module 15. Further, other in-vehicle equipment 16, such as various types of ECUs for controlling an engine, transmission, brakes, and so forth, sensor modules other than those described above, and human-machine interface (HMI) equipment, and so forth, is connected to the in-vehicle communication network 11. The ECU 20 and each piece of in-vehicle equipment (12 to 16) are started in response to an on operation being performed regarding main power of the vehicle 10. The vehicle 10 is provided with a power switch 17 for turning the main power on and off.

The ECU 20 has a processor 21 and memory 22. Various types of applications are stored in the memory 22. The ECU 20 provides various types of services by the processor 21 reading applications from the memory 22 and performing execution thereof.

### Regarding Services Provided by ECU 20

Next, services provided by the ECU 20 will be described with reference to FIG. 2. In the following description, service-providing applications stored in the memory 22 of the ECU 20 are classified into a first group, a second group, a third group, and a fourth group. Each group is classified in accordance with in-vehicle equipment necessary to provide services. FIG. 2 shows a list of in-vehicle equipment necessary for each group of applications to provide services. In FIG. 2, in-vehicle equipment necessary for each group of applications to provide services is indicated by circles.

The first group is made up of applications AP1 that need the camera module 12 to provide services. The applications AP1 of the first group include an application for a back guide monitor (BGM) and an application for rear camera detection (RCD). The BGM is a service for displaying images rearward from the vehicle when the vehicle 10 is traveling in reverse. The RCD is a service that detects the situation rearward from the vehicle when backing out of a parking space, and warns a driver when there are pedestrians or the like.

The second group is made up of applications AP2 that need the camera module 12 and the sonar module 13 to provide services. The applications AP2 of the second group include an application for parking support braking (PKSB) and an application for pre-crash safety (PCS). PKSB is a service that automatically applies the brakes when there is a possibility that a vehicle body will come into contact with an obstruction when parking. PCS is a service that gives a warning and causes the vehicle 10 to perform evasive actions when there is a possibility that the vehicle will collide with a vehicle traveling ahead.

The third group is made up of applications AP3 that need the DMC module 14 to provide services. The applications AP3 of the third group include applications for facial recognition of the driver.

The fourth group is made up of applications AP4 that need the camera module 12, the sonar module 13, the DMC module 14, and the Lidar module 15 to provide services. The applications AP4 of the fourth group include applications for automated driving of the vehicle 10.

### Version Match Check

These groups of applications AP1 to AP4 are configured to start providing services under the condition that the version match check is completed. In the following description, the term “version match check” will be abbreviated to “VMC”. One of the purposes of the VMC is to confirm whether an application to be checked matches the configuration of the vehicle 10 in which the ECU 20 is installed. For VMC of the applications AP1 of the first group, whether the camera module 12 is installed in the vehicle 10 is confirmed. For VMC of the applications AP2 of the second group, whether the camera module 12 and the sonar module 13 are installed in the vehicle 10 is confirmed. For VMC of the applications AP3 of the first group, whether the DMC module 14 is installed in the vehicle 10 is confirmed. For VMC of the applications AP4 of the fourth group, whether the camera module 12, the sonar module 13, the DMC module 14, and the Lidar module 15, are installed in the vehicle 10 is confirmed.

The VMC is performed based on equipment information acquired from each piece of in-vehicle equipment. In the case of the present embodiment, a part number of each piece of in-vehicle equipment is used as the equipment information. The part number is an identification number assigned to each model of in-vehicle equipment. In-vehicle equipment that is the object of VMC, i.e., the camera module 12, the sonar module 13, the DMC module 14, and the Lidar module 15, each has memory in which the respective part number is stored. Upon starting being completed, the camera module 12, the sonar module 13, the DMC module 14, and the Lidar module 15 then transmit their part numbers to the ECU 20.

The memory 22 of the ECU 20 stores a program for VMC that collectively carries out VMC of each application for providing services. After the ECU 20 is started, the processor 21 reads the VMC program from the memory 22 and performs execution thereof, thereby performing VMC processing. The memory 22 also stores a VMC table, which is a data table for the VMC processing.

FIG. 3 shows a configuration of the VMC table. In the VMC table, part numbers of in-vehicle equipment that need to be referenced are registered for each application. For example, in the case of a BGM application belonging to the first group, the part number of the camera module 12 is registered. Also, in the case of the PKSB application belonging to the second group, the part numbers of the camera module 12 and the sonar module 13 are registered, respectively.

The VMC processing is performed in the following manner. In the VMC processing, the processor 21 performs VMC for each application by referencing the part number received from each piece of in-vehicle equipment with the part number registered in the VMC table. When all part numbers corresponding to the relevant application registered in the VMC table have been referenced, the processor 21 determines that VMC of that application has been completed. Each time VMC of each application is completed, the processor 21 notifies the relevant application of the completion of VMC.

Notification of VMC completion is performed using, for example, a VMC completion flag. The VMC completion flag is a flag that is prepared for each application, indicating whether VMC is completed, and is held in the memory 22. The VMC completion flag of each application is cleared when the ECU 20 is started. When VMC is completed, the processor 21 sets the VMC completion flag of the relevant application. Each of the applications refers to their respective VMC completion flags to determine whether VMC is completed.

### Advantageous Effects of Embodiment

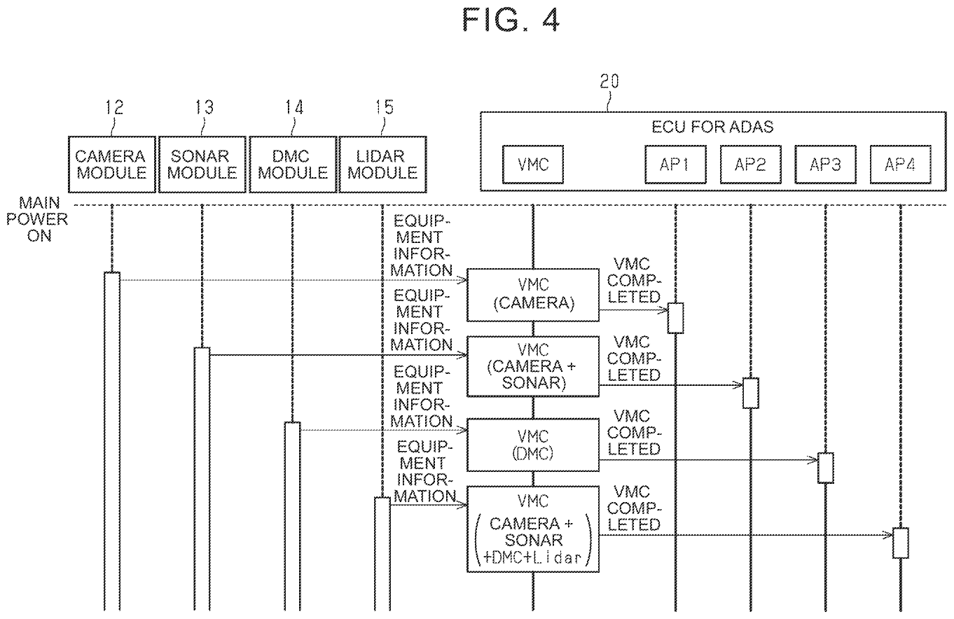

The operations and effects of the present embodiment will be described with reference to FIG. 4 FIG. 4 shows the processing procedures after the main power is turned on. Note that FIG. 4 shows processing procedures when VMC is successful for all of each of the applications.

When the main power is turned on and the ECU 20 is started, the processor 21 starts the VMC processing. Also, when the main power is turned on, the camera module 12, the sonar module 13, the DMC module 14, and the Lidar module 15 begin preparations for starting. Upon starting being completed, the camera module 12, the sonar module 13, the DMC module 14, and the Lidar module 15 each transmit their respective part numbers to the ECU 20. In the VMC processing, the processor 21 of the ECU 20 performs VMC for each application by referencing the part number that is received with the part number registered in the VMC table.

In the case of FIG. 4, the camera module 12 completes starting first, and transmits the part number. As described above, the camera module 12 is the only in-vehicle equipment that the each of the applications AP1 of the first group needs to provide services. Accordingly, in the VMC processing, the processor 21 determines that VMC of each of the applications AP1 of the first group is completed at this point in time. The processor 21 then notifies each of the applications AP1 of the first group of the VMC completion. Thereafter, each of the applications AP1 of the first group start their services when all start conditions other than VMC completion are satisfied.

In the case of FIG. 4, following the camera module 12 starting and transmitting the part number, the sonar module 13 completes starting and transmits the part number thereof to the ECU 20. Each of the applications AP2 of the second group use the camera module 12 and the sonar module 13 as in-vehicle equipment necessary for providing services. Accordingly, in the VMC processing, the processor 21 notifies each of the applications AP2 of the second group regarding the completion of VMC after ending referencing of the part number of the sonar module 13.

Furthermore, in the case of FIG. 4, the DMC module 14 completes starting following the sonar module 13, and transmits the part number thereof to the ECU 20. Each of the applications AP3 of the third group use the DMC module 14 as in-vehicle equipment necessary for providing services. Accordingly, in the VMC processing, the processor 21 notifies each of the applications AP3 of the third group regarding completion of VMC after ending referencing of the part number of the DMC module 14.

In the case of FIG. 4, the Lidar module 15, last of all, completes starting and transmits the part number thereof to the ECU 20. Thus, referencing of all part numbers of the camera module 12, the sonar module 13, the DMC module 14, and the Lidar module 15 ends. Accordingly, the processor 21 notifies each of the applications AP4 of the fourth group of VMC completion.

Among the applications executed by the ECU 20, there are many applications that need to reference the part numbers of the same in-vehicle equipment in order to perform VMC. For example, referencing of the part number of the camera module 12 is necessary for VMC of the applications of the first group for BGM and RCD, the applications of the second group for PKSB and PCS, and the applications of the fourth group for automatic driving.

When each application individually acquires the part number from the in-vehicle equipment to perform VMC, each piece of in-vehicle equipment needs to transmit the part number to the ECU 20 a plurality of times. As a result, there is a risk that excessive processing overhead will occur, creating a delay in starting services. On the other hand, in the in-vehicle control device according to the present embodiment, the processor 21 collectively acquires the part number from each piece of in-vehicle equipment necessary for VMC of each application in the VMC processing. Accordingly, VMC of each application can be performed, simply by each piece of in-vehicle equipment transmitting the part number thereof just once.

In the present embodiment, the processor 21 corresponds to a processing circuit for equipment information management. The processor 21 also corresponds to a processing circuit that executes each of the applications for providing services.

According to the present embodiment, the following effects can be obtained.

(1) The ECU 20 according to the present embodiment includes a processor 21 that performs the VMC processing in which acquisition of equipment information from in-vehicle equipment for VMC of each application is collectively performed. That is to say, in the VMC processing, the processor 21 collectively acquires equipment information for VMC of each application. More specifically, in the VMC processing, when there are multiple applications that use equipment information of the same in-vehicle equipment for VMC, the processor 21 collectively acquires equipment information for VMC of these applications all at once. Accordingly, the occurrence of excessive processing overhead due to VMC is suppressed.

(2) When each application performs VMC individually, a great number of applications may attempt to reference equipment information at the same time, in response to acquisition of equipment information from in-vehicle equipment, resulting in excessive processing overhead. In the in-vehicle control device according to the present embodiment, the processor 21 collectively references the equipment information for VMC of each application in the VMC processing. Accordingly, reference of equipment information for VMC of multiple applications is collectively performed. Thus, the occurrence of excessive processing overhead due to VMC is suppressed.

(3) When excessive processing overhead occurs during VMC, completion of VMC may be delayed. Accordingly, the amount of time taken until VMC is completed and the service can be started, i.e., the service start waiting time, varies greatly. According to the present embodiment, delays in VMC completion due to excessive processing overhead are less likely to occur, and accordingly variance in service start waiting time can be suppressed. Thus, managing the service start waiting time is facilitated.

(4) VMC results may vary among applications. One example is when the applications AP1 of the first group include an application that requests a camera module 12 with a different part number. There are cases in which handling such variance in VMC results becomes necessary. When each application performs VMC independently, handling such variance in VMC results becomes difficult. For example, variance in VMC results cannot handled until each application acquires the VMC results of other applications. In contrast, according to the present embodiment, the processor 21 performs VMC for each application in the VMC processing, and notifies each application of the results. That is to say, the VMC of each application is performed within the same processing. Confirmation of the results of VMC for each application is easy, and accordingly dealing with variance in the results of VMC is easy.

(5) In the present embodiment, the processor 21 executing each application also executes the VMC processing. That is to say, the in-vehicle control device is configured such that the same processing circuit executes each application and the VMC processing. Accordingly, increase in the number of parts can be suppressed.

### Other Embodiments

### Regarding VMC Processing

In the VMC processing, the processor 21 in the in-vehicle control device of the above-described embodiment acquires equipment information from in-vehicle equipment, and also performs VMC of each application based on the equipment information that is acquired. The in-vehicle control device may be configured so that the VMC processing only acquires the equipment information and VMC is performed by each application.

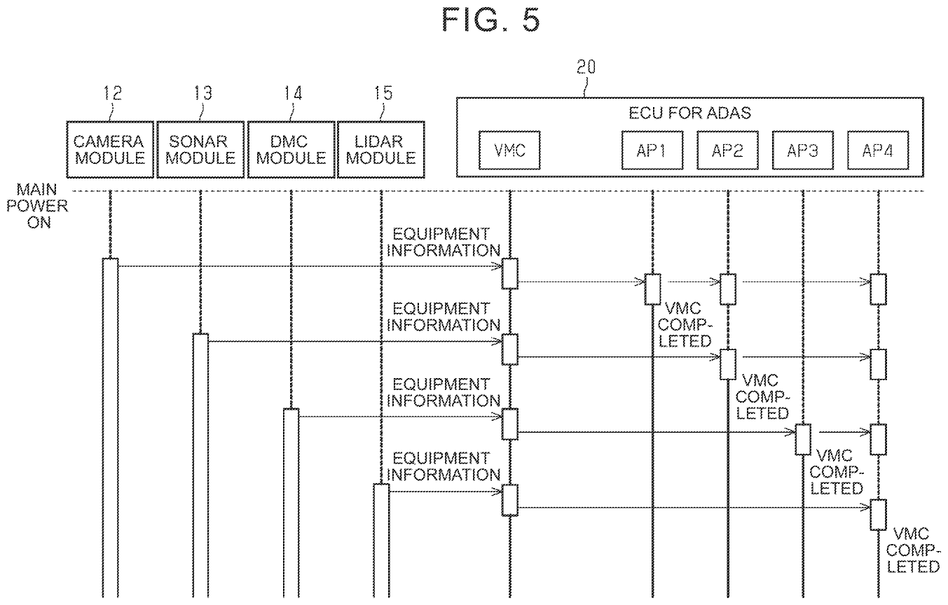

FIG. 5 shows an example of processing procedures after the main power is turned on in such a case. In the case of FIG. 5, starting of the camera module 12, the sonar module 13, the DMC module 14, and the Lidar module 15, is completed in this order, in the same way as the case in FIG. 4.

In the VMC processing, upon receiving the part number of the camera module 12, the processor 21 notifies the same part number to each application that needs the same part number for VMC. Specifically, in the VMC processing, the processor 21 notifies the part number of the camera module 12 to each of the applications AP1, AP2, and AP4 in the first group, the second group, and the fourth group. Next, when the part number of the sonar module 13 is received, the processor 21 notifies the part number thereof to each of the applications AP2 and AP4 in the second group and the fourth group. Also, when the part number of the DMC module 14 is received, the processor 21 notifies the part number thereof to each of the applications AP3 and AP4 in the third group and the fourth group. Further, when the part number of the Lidar module 15 is received, the processor 21 notifies the part number thereof to each of the applications AP4 in the fourth group. In each application, the processor 21 performs VMC based on the part number notified by the VMC processing. Thus, the processor 21 in this case sorts the part numbers received from the pieces of in-vehicle equipment to each application in the VMC processing.

In such cases as well, in the VMC processing, the processor 21 collectively acquires equipment information from the in-vehicle equipment for VMC of each application. Thus, occurrence of excessive processing overhead by VMC can be suppressed in such cases as well.

### Regarding Equipment Information

Information other than the part number may be used as the equipment information, such as the manufacturing number or the like of the in-vehicle equipment. Also, when there are differences in versions of a program of the in-vehicle equipment, the version of the program may be included in the equipment information.

The in-vehicle equipment from which the ECU 20 acquires the equipment information may include in-vehicle equipment other than sensor modules such as other ECUs or the like, for VMC.

In the above-described embodiment, each piece of in-vehicle equipment transmits equipment information thereof to the ECU 20 after completion of starting, but an arrangement may be made in which the ECU 20 requests the in-vehicle equipment for transmission of equipment information, and the in-vehicle equipment responds to this request by returning the equipment information thereof.

### Regarding When to Perform VMC

In the above embodiment, VMC of each application is performed after the ECU 20 is started, but VMC may be performed at other times. For example, VMC may be performed while a service is being performed, and the service may be stopped when it is determined that there is a mismatch. Also, VMC may be performed when the application of the ECU 20 is updated or the hardware configuration of the vehicle 10 is changed. Furthermore, a maintenance worker or the like may manually set the timing for performing VMC.

### Regarding When to Start Applications

In the above-described embodiment, each application is configured to start after the ECU 20 is started, and also to start a service in response to notification of VMC completion. In the VMC processing, the processor 21 may start each application upon completion of VMC. In this case, each application starts a service upon starting.

### Regarding Configuration of In-vehicle Control Device

A processing circuit for performing the VMC processing may be provided separately from the processing circuit for executing applications for providing services. Also, such a processing circuit for the VMC processing can be installed in housing of the ECU 20, or in housing separate from the housing of the ECU 20.

The configuration of the ECU 20 of the above embodiment may be applied to in-vehicle control devices other than for ADAS.

An in-vehicle control device according to a first aspect of the present disclosure executes a plurality of applications that provide a service. The in-vehicle control device includes a processing circuit configured to collectively acquire, from in-vehicle equipment, equipment information based on which a version match check of each of the applications is performed, and the equipment information is information on the in-vehicle equipment. The version match check is a check performed for confirming that in-vehicle equipment necessary for providing the service is installed in a vehicle. Each of the applications is configured to start the service under a condition that the version match check is completed.

In the in-vehicle control device according to the above aspect, the processing circuit may be configured to perform the version match check based on the equipment information, and notify the applications of a result of the version match check.

In the in-vehicle control device according to the above aspect, each of the applications may be configured to perform the version match check based on the equipment information acquired by the processing circuit.

In the in-vehicle control device according to the above aspect, the processing circuit may be configured to execute the applications.

A vehicle according to a second aspect of the present disclosure includes the in-vehicle control device according to the first aspect.

In the vehicle according to the above aspect, the processing circuit may be configured to perform the version match check based on the equipment information, and notify the applications of a result of the version match check.

In the vehicle according to the above aspect, the applications may be configured to perform the version match check based on the equipment information acquired by the processing circuit.

In the vehicle according to the above aspect, the processing circuit may be configured to execute the applications.

A method according to a third aspect of the present disclosure is a method for performing a version match check of a plurality of applications that provides a service, in an in-vehicle control device that executes the applications. The method includes collectively acquiring, by the in-vehicle control device executing a single program stored in the in-vehicle control device, from in-vehicle equipment, equipment information based on which the version match check is performed, and the equipment information is information on the in-vehicle equipment. The version match check is a check performed for confirming that in-vehicle equipment necessary for providing the service is installed in a vehicle. Each of the applications is configured to start the service under a condition that the version match check is completed.

In the method according to the above aspect, the program may be configured to perform the version match check based on the equipment information, and notify the applications of a result of the version match check.

In the method according to the above aspect, each of the applications may be configured to perform the version match check based on the equipment information acquired by the program.

In the method according to the above aspect, the program may be executed by processing circuit that executes the applications.

A non-transitory storage medium according to a fourth aspect of the present disclosure stores instructions that are executable by an in-vehicle control device, and that cause the in-vehicle control device to perform the following functions. The in-vehicle control device is configured to execute a plurality of applications that provides a service. The functions include collectively acquiring, from in-vehicle equipment, equipment information based on which a version match check of each of the applications is performed, the equipment information being information on the in-vehicle equipment. Each of the applications is configured to start the service under a condition that the version match check is completed; and the version match check is a check for confirming that in-vehicle equipment necessary for providing the service is installed in a vehicle.

In the non-transitory storage medium according to the above aspect, the functions may include performing the version match check based on the equipment information, and notifying the applications of a result of the version match check.

In the non-transitory storage medium according to the above aspect, each of the applications may be configured to perform the version match check based on the equipment information acquired by the functions.

In the non-transitory storage medium according to the above aspect, the instructions may be executed by a processing circuit executing the applications.

What is claimed is:

1. An in-vehicle control device, configured to execute a plurality of applications that provides a service, the in-vehicle control device comprising a processing circuit configured to collectively acquire, from in-vehicle equipment, equipment information based on which a version match check of each of the applications is performed, the equipment information being information on the in-vehicle equipment, wherein
the version match check is a check performed for confirming that in-vehicle equipment necessary for providing the service is installed in a vehicle, and
each of the applications is configured to start the service under a condition that the version match check is completed.

2. The in-vehicle control device according to claim 1, wherein the processing circuit is configured to
perform the version match check based on the equipment information, and
notify the applications of a result of the version match check.

3. The in-vehicle control device according to claim 1, wherein each of the applications is configured to perform the version match check based on the equipment information acquired by the processing circuit.

4. The in-vehicle control device according to claim 1, wherein the processing circuit is configured to execute the applications.

5. A vehicle comprising the in-vehicle control device according to claim 1.

6. A method for performing a version match check of a plurality of applications that provides a service, in an in-vehicle control device that executes the applications, the method comprising collectively acquiring, by the in-vehicle control device executing a single program stored in the in-vehicle control device, from in-vehicle equipment, equipment information based on which the version match check is performed, the equipment information being information on the in-vehicle equipment wherein:
the version match check is a check performed for confirming that in-vehicle equipment necessary for providing the service is installed in a vehicle; and
each of the applications is configured to start the service under a condition that the version match check is completed.

7. A non-transitory storage medium storing instructions that are executable by an in-vehicle control device configured to execute a plurality of applications providing a service, and that cause the in-vehicle control device to perform functions comprising collectively acquiring, from in-vehicle equipment, equipment information based on which a version match check of each of the applications is performed, the equipment information being information on the in-vehicle equipment, wherein:
each of the applications is configured to start the service under a condition that the version match check is completed; and
the version match check is a check for confirming that in-vehicle equipment necessary for providing the service is installed in a vehicle.
